(19) United States
(12) Patent Application Publication
(10) Pub. No.: US 2011/0220675 A1
(43) Pub. Date: Sep. 15, 2011

(54) Bowzer buddy - a green, all-in-one dog walking solution. With 100% bio-degradable self closing waste pick-up bags

(76) Inventor: Marlies Barton, Park Ridge, IL (US)

(21) Appl. No.: 12/951,595

(22) Filed: Nov. 22, 2010

Related U.S. Application Data
(60) Provisional application No. 61/340,197, filed on Mar. 15, 2010.

(51) Int. Cl. B65D 83/00; F16B 2/02; A44B 19/00

(52) U.S. Cl. 221/45; 24/3.11

(57) ABSTRACT

A green, all-in-one dog walking solution, with 100% bio-degradable drawstring waste pick-up bags in the form of a compact pouch for carrying and dispensing waste bags, having a compartment that can be filled with folded waste bags, which are easily accessible through an opening with overlapping covers across the pouch, by reaching into the opening with one hand and pulling on the first folded waste bag.

The pouch includes an additional compartment for storing miscellaneous items, accessible with one hand through an arched top with a zipper opening.

The waste bags are individually folded to the size of the compartment and stacked in a way that one bag can be removed at a time.

### Field of the Invention

The present invention relates to a green, all-in-one dog walking solution, with 100% bio-degradable drawstring waste pick-up bags according to the preamble to Patent-claim 1.

### BACKGROUND OF THE INVENTION

In many developed countries owners who walk their pets are used to picking up the waste their pets leave on the way. This is generally due to health and environmental reasons and often rules and regulations are in place, requiring the pet owners to pick up the waste of their pets. Several solutions are known, which allow convenient carrying of the waste pick-up tool with the leash used for leading the dog. An example is shown in patent application US 2009/0261604 A1, where a retractable grasping device is combined with a retractable leash. The presented solution allows the pet owner to use just one hand for picking up pet waste, while simultaneously holding on to the leash with the same hand. While this tool may be useful for people with limited abilities to bend over and pick up waste or who need the second hand for support, e.g. to hold a walking cane, it is rather large and may be inconvenient to the owner.

Another well known solution for picking up pet waste is the use of disposable bags. One solution for carrying several such bags for repeated pick-up of pet waste is a dispenser as presented in patent application US 2008/0173662 A1. The solution presented is a compact container, which can be filled with a roll pet waste collection bags as are readily available in the market. It also shows a means of attaching the container to another object, e.g. a leash used for leading the pet. While this solution allows dispensing of waste collection bags, it is limited to the use for collection bags on a roll and tearing off one bag from the roll requires the use of both hands, which is difficult, when holding the leash at the same time.

The commonly used bags for pet waste pick-up generally can not be closed easily to prevent odor from coming out and to prevent the waste from falling out of the bag if it is accidentally dropped. Usually a knot needs to be tied in the top part of the bag, requiring the bag to be longer than necessary for containing the waste or the waste bag need to be immediately placed in an additional container, which can be closed by other means.

### SUMMARY OF THE INVENTION

One object of the present invention is to provide a green, all-in-one dog walking solution, with 100% bio-degradable drawstring waste pick-up bags in the form of a compact pouch for carrying and dispensing waste bags. The pouch has a compartment that can be filled with folded waste bags, which are easily accessible through an opening with overlapping covers across the pouch, by reaching into the opening with one hand and pulling on the first folded waste bag.

Another object is to provide an additional compartment in the pouch for storing miscellaneous items, also accessible with one hand. The pouch has an arched top with a zipper opening. The pouch has an arched zipper at the top connected to a karabiner, which allows opening of the zipper with one hand by moving the pouch sideways.

Another object is to provide waste bags, which can be easily placed in and removed from the corresponding compartment of the pouch. For this the bags should be individually folded to the size of the compartment and stacked in a way that one bag can be removed at a time. To provide an additional benefit for the environmentally conscious user the bags are 100% bio-degradable.

Another object is to simplify the process of closing the waste bag after use while reducing the amount of waste created by using these bags. Instead of requiring a knot at the top of the bag to close it, the bags are equipped with a drawstring at the top, enabling the bags to be closed very easily. Without the need of the bag to be long enough to allow a knot to be made at the top of the full bag it is also an advantage that less material can be used for the waste bag.

### BRIEF DESCRIPTION OF THE DRAWINGS

In the drawing

FIG. 1. is a front view of the pouch with the waste bag compartment closed.

FIG. 2 is a front view of the pouch with the waste bag compartment open.

FIG. 3 is a view of the pouch before the zipper is being closed.

### DETAILED DESCRIPTION OF THE INVENTION

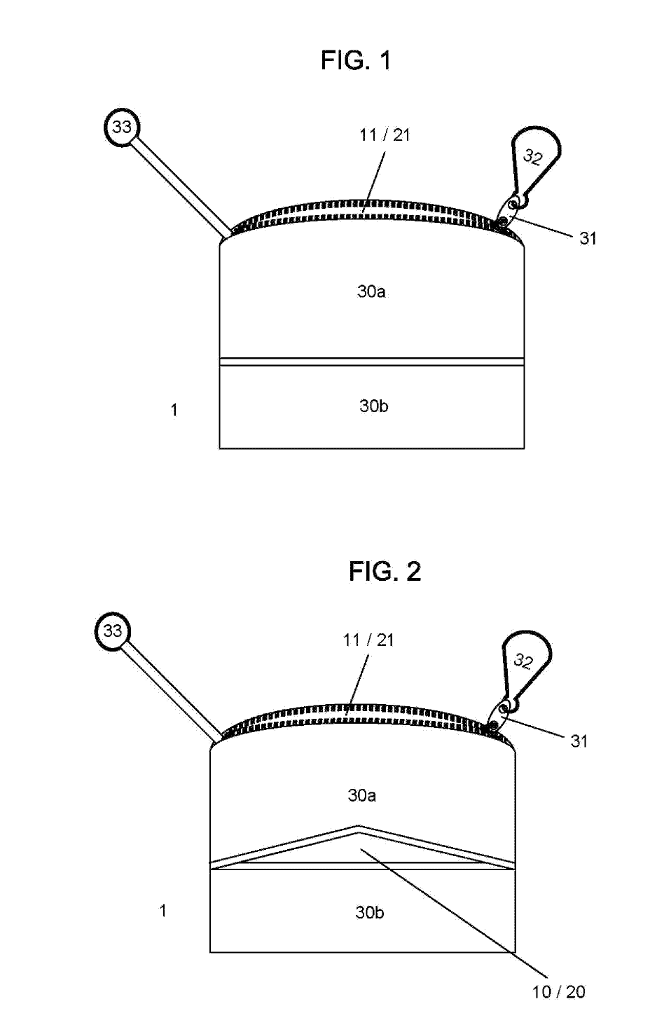

A green, all-in-one dog walking solution, with 100% bio-degradable drawstring waste pick-up bags 99 according to a preferred embodiment of the present invention is shown in FIG. 1. The pouch 1 contains two compartments, a front compartment 10 accessible through opening 20 and a main compartment 11, accessible through opening 21, which can be closed using zipper 31.

The front compartment 10 is designed to store a stack of bags 99 for picking up and disposing of pet waste. The front compartment 10 is closed by a top cover 30a, which overlaps the bottom cover 30b, thus protecting the contents from rain and sunshine and preventing them from falling out. Access to the front compartment is gained by placing at least one finger underneath the top cover 30a and reaching upwards past the top end of the bottom cover 30b. By spreading the fingers in this position the top cover 30a is moved so that opening 20 allows access to the contents of this compartment as shown in FIG. 2. In this way a bag 99 can be removed from the front compartment 10 by grasping it with the fingers previously used for opening the compartment, without using the second hand. As soon as the top bag 99 of the stack is removed the top cover 30a returns to its normal position, overlapping the bottom cover 30b and closing the opening 20 so that the remaining bags 99 of the stack are protected again.

As soon as the last bag 99 of the stack is removed from the front compartment 10, the pouch can be refilled with a new stack of bags 99. In the preferred embodiment the stack contains 10-20 bags 99 which are individually folded.

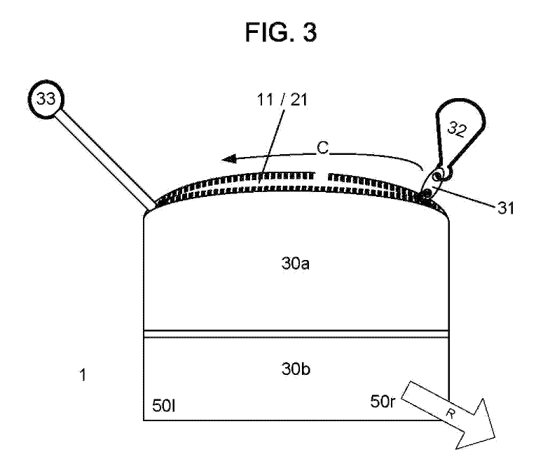

The main compartment 11 is accessible through opening 21, which can be closed by using zipper 31. It can be used for storing additional waste pick-up bags 99, keys, money, a flashlight or other personal items. A keychain 33 is provided on the inside of the main compartment 11 allowing a key to be attached, so that it cannot accidentally fall out of the main compartment 11 if this is left open. A karabiner 32 can be connected to zipper 31 providing a means for attaching the pouch 1 to a leash or a belt loop or some other object. The arched form of zipper 31 allows easy opening or closing of the main compartment 11 of the pouch by gently pulling the lower corners 50r or 50l of the pouch with one hand. FIG. 3 shows the direction R in which the pouch can be pulled, when the karabiner 32 is fixed, so that the zipper 31 of pouch 1 is moved in the direction C for closing the main compartment of the pouch.

As the description shows removing a bag 99 from the front compartment 10, unfolding the bag 99 for waste pick-up and opening and closing the zipper 32 of the main compartment 11 can be done using just one hand. This allows the other hand to be freely used for another activity such as holding the pet leash.

In the preferred embodiment the waste pick-up bags 99 used are folded and stacked individually, in a way similar to boxed tissues, so that one bag can be removed at a time, without another one falling out or the requirement to separate it from the next bag. Each bag 99 is folded in half on the longer side and then again in half from both the front and the back to form an accordion pleat with 4 layers. The opening of the bag 99 is then placed on the top and the bag 99 folded one last time in the other direction so that the drawstring is on the outside and the folded bag 99 forms a rectangle with similar length on both sides. This folding method allows the bag 99 to easily unfold by shaking it with the hand, with which it was removed from the pouch, without the need to use the other hand. The stack of folded bags 99 is formed by placing two or more bags on top of each other with the same orientation of the bag opening and drawstring.

The waste pick-up bags are made of 100% bio-degradable material, following the general requirement to be environmentally safe. Another environmental benefit is achieved by using drawstring bags, which can be shorter than the commonly used bags, which require additional length in order to allow a knot to be tied for closing the bag after use. Also the use of the drawstring bag simplifies the process of closing the bag compared to tying a knot.

1. A device for storing and dispensing pet waste collection bags comprising:
a pouch with at least one bag compartment for storing new pet waste bags;
a stack of at least two pet waste collection bags placed in said compartment stacked in a way that they can easily be removed from the pouch individually using just one hand;
said waste collection bags made of 100% bio-degradable material.

2. The device of claim 1 wherein the waste collection bags are drawstring bags.

3. The device of claim 1 wherein the waste collection bags are folded by forming a accordion pleat with 4 layers and one transversal fold such that the bag opening is on the top of the folded bag.

4. The device of claim 1 wherein said bag compartment is closed by two partially overlapping covers on one side of the pouch.

5. The device of claim 1 wherein said pouch contains a second compartment.

6. The device of claim 5 wherein said second compartment can be closed by a zipper located on the top side of the pouch.

7. The device of claim 6 wherein a means is attached to said zipper, allowing attaching of said pouch to another object such as a pet leash or belt loop.

8. The device of claim 7 wherein said means for attaching the pouch is a karabiner.

9. The device of claim 7 wherein the zipper has an arched top allowing the zipper to be opened and closed by pulling on the lower corners of the pouch with one hand, if the pouch is attached to another object.
